(19) United States
(12) Patent Application Publication
(10) Pub. No.: US 2025/0268248 A1
(43) Pub. Date: Aug. 28, 2025

(54) ANTIBACTERIAL POLYMER AND PROCESS OF PREPARING THE SAME

(71) Applicant: BASF SE, Ludwigshafen am Rhein (DE)

(72) Inventors: Li Chao SUN, Shanghai (CN); Shi Jie QIAO, Shanghai (CN); Liangzhi HONG, Guangzhou City (CN); Xiangyue HUANG, Guangzhou City (CN); Chengdong ZHAN, Guangzhou City (CN)

(21) Appl. No.: 18/857,485

(22) PCT Filed: Apr. 17, 2023
(86) PCT No.: PCT/EP2023/059883

§ 371 Date: Oct. 17, 2024

(30) Foreign Application Priority Data
Apr. 20, 2022 (WO) PCT/CN2022/087931

(51) Int. Cl. A01N 25/10; A01P 1/00; C08F 220/18; C08F 220/34

(52) U.S. Cl. CPC A01N 25/10; A01P 1/00; C08F 220/1811; C08F 220/34

(57) ABSTRACT

The present invention relates to a polymer, containing a structural unit A′ derived from a monomer A and a moiety B′ derived from a compound B, wherein monomer A contains a nitrogen atom and a polymerizable carbon-carbon double bond, and compound B is selected from a group consisting of bicyclic monoterpenes, monocyclic monoterpenes, acyclic monoterpenes, and C₁₋₁₀ alkyl-substituted phenol, wherein the bicyclic monoterpene is selected from pinene-based compounds containing hydroxy, carene-based compounds containing hydroxy, chrysanthanol, and fenchol. The present invention further relates to processes of preparing the polymer.

### TECHNICAL FIELD

The present invention relates to a novel polymer. In particular, the present invention relates to an antibacterial polymer, and to a process of preparing the polymer.

### BACKGROUND

Common biocides like BIT/MIT/CIT used in the architectural field are facing more and more restricted regulations due to their allergenicity or safety issue to human beings.

Obtaining the comparable long shelf-life of paints or dispersions without using traditional biocides is a big challenge in the field.

In addition, common antibiotics in medical field also suffer increasing drug resistance risk of bacteria.

Therefore, there is a strong need to provide an antibacterial product that is effective at lower minimum inhibitory concentrations than known naturally-derived polymer, and has less allergenicity, better safety than traditional biocides. In addition, it is also needed that the antibacterial product can be prepared from raw materials that are easily obtainable at low cost.

### SUMMARY OF THE INVENTION

It is an objective of the present invention to provide a polymer that is antibacterial, and a process of preparing the polymer. The polymer of the present invention and the polymer prepared by the process of the present invention have improved antibacterial effects and can be prepared from raw materials that are easily obtainable, preferably obtainable from natural plants.

It has been surprisingly found that the above objectives can be achieved by following embodiments:

1. A polymer, containing a structural unit A′ derived from a monomer A and a moiety B′ derived from a compound B, wherein:
monomer A contains a nitrogen atom and a polymerizable carbon-carbon double bond, and
compound B is selected from a group consisting of bicyclic monoterpenes, monocyclic monoterpenes, acyclic monoterpenes, and C₁₋₁₀ alkyl-substituted phenol,
wherein the bicyclic monoterpene is selected from pinene-based compounds containing hydroxy, carene-based compounds containing hydroxy, chrysanthanol, and fenchol.

2. The polymer of embodiment 1, wherein the nitrogen atom in monomer A is substituted with one or two C₁₋₁₀ alkyl groups, preferably the nitrogen atom in monomer A is substituted with one or two groups selected from a group consisting of methyl, ethyl, propyl, butyl, and pentyl, more preferably the nitrogen atom in monomer A is a tertiary nitrogen atom.

3. The polymer of embodiment 1 or 2, wherein monomer A is selected from (di-C₁₋₅alkyl-amino)C₁₋₅alkyl (meth)acrylate and (C₁₋₅alkyl-amino)C₁₋₅alkyl (meth)acrylate, preferably (di-C₁₋₃alkyl-amino)C₁₋₃alkyl (meth)acrylate and (C₁₋₃alkyl-amino)C₁₋₃alkyl (meth)acrylate, more preferably monomer A is N,N-dimethylaminomethyl (meth)acrylate and/or N,N-dimethylaminoethyl (meth)acrylate.

4. The polymer of any one of embodiments 1 to 3, wherein monomer A is hydrophilic.

5. The polymer of any one of embodiments 1 to 4, wherein compound B carries a OH group; preferably compound B is selected from a group consisting of citronellol, menthol, thymol, and carvacrol; more preferably, compound B is citronellol, menthol, thymol, or carvacrol.

6. The polymer of any one of embodiments 1 to 5, wherein compound B is modified to a compound B-based initiator, or to a monomer C containing a polymerizable carbon-carbon double bond and the moiety B′, and the moiety B′ is incorporated into the polymer via the compound B-based initiator and/or monomer C.

7. The polymer of any one of embodiments 1 to 6, wherein the polymer is formed by atom transfer radical polymerization of monomer A, and moiety B′ is positioned at the end of the polymer, wherein the average number of structural unit A′ in the polymer is in the range from 5 to 150, preferably in the range from 5 to 120, more preferably in the range from 8 to 53, or in the range from 9 to 98.

8. The polymer of embodiment 6, wherein the polymer is formed by radical polymerization of monomer A and monomer C,
wherein the average number of structural unit A′ is in the range from 10 to 50, preferably in the range from 10 to 30, more preferably in the range from 12 to 18; and
the average number of the structural unit derived from monomer C is in the range from 1 to 10, preferably in the range from 1 to 7, more preferably in the range from 1 to 4.

9. The polymer of embodiment 8, wherein the polymer is a random copolymer.

10. A process of preparing the polymer of any one of embodiments 1 to 7, comprising:
(1) modifying compound B to prepare a compound B-based initiator; and
(2) polymerizing monomer A via atom transfer radical polymerization using the compound B-based initiator obtained in step (1), to obtain the polymer.

11. The process of embodiment 10, wherein step (1) is carried out by modifying compound B with an agent having formula RCOX, wherein X is a halogen, preferable Cl or Br; R is a C₁₋₆ alkyl substituted with one halogen atom, preferably the halogen atom is Cl or Br; more preferably the agent is α-bromoisobutyryl bromide.

12. The process of embodiment 10 or 11, wherein step (2) of the process is carried out in the presence of a catalyst system containing a catalyst and a ligand, preferably the catalyst is CuBr, and the ligand is N,N,N′,N″,N″-pentamethyldiethylenetriamine.

13. The process of embodiment 12, wherein the molar ratio of the compound B-based initiator to the catalyst for step (2) is in the range from 1:1 to 1:3, preferably in the range from 1:1 to 1:2.

14. The process of any one of embodiments 10 to 13, wherein step (2) is carried out in the presence of a solvent, preferably the solvent is a water-miscible alcohol, more preferably the solvent is methanol, ethanol or propanol, most preferably the solvent is methanol.

15. The process of any one of embodiments 10 to 14, wherein step (2) is carried out at a temperature of 35° C. to 65° C., preferably 40° C. to 60° C., more preferably 45° C. to 55° C.

16. The process of any one of embodiments 10 to 15, wherein step (2) is carried out for a time of 4 to 40 hours, preferably 4 to 30 hours, more preferably 4 to 24 hours.

17. The process of any one of embodiments 10 to 16, wherein the polymerization degree of the polymer from step (2) is in the range from 10 to 150, preferably in the range from 10 to 120, more preferably in the range from 10 to 100.

18. A process of preparing a polymer of embodiment 8 or 9, comprising:
(i) modifying a compound B to prepare a monomer C containing a polymerizable carbon-carbon double bond and a moiety B′ derived from compound B; and
(ii) polymerizing the monomer C and monomer A via radical polymerization, in the presence of an initiator and a chain-transfer agent, to obtain the polymer;
   wherein monomer A contains a nitrogen atom and a polymerizable carbon-carbon double bond, and
   compound B is selected from a group consisting of bicyclic monoterpenes, monocyclic monoterpenes, acyclic monoterpenes, and C₁₋₁₀ alkyl-substituted phenol,
   wherein the bicyclic monoterpene is selected from pinene-based compounds containing hydroxy, carene-based compounds containing hydroxy, chrysanthanol, and fenchol.

19. The process of embodiment 18, wherein step (i) is carried out by modifying compound B with an unsaturated carbonyl halide, preferably acryloyl chloride or methacryloyl chloride, more preferably methacryloyl chloride.

20. The process of embodiment 18 or 19, wherein step (ii) is carried out in the presence of a solvent, preferably the solvent is selected from esters, for example, n-butyl acetate, ethyl acetate, 1-methoxyprop-2-yl acetate, and 2-methoxyethyl acetate, more preferably the solvent is ethyl acetate.

21. The process of any one of embodiments 18 to 20, wherein the initiator used in step (ii) is an azo type of initiator, preferably 2,2-azobisisobutyronitrile.

22. The process of any one of embodiments 18 to 21, wherein the chain-transfer agent used in step (ii) is a mercaptan, preferably the chain-transfer agent used in step (ii) is methyl-3-mercaptopropionate, butyl-3-mercaptopropionate, i-octyl-3-mercaptopropionate, i-decyl-3-mercaptopropionate, dodecyl-3-mercaptopropionate, octadecyl-3-mercaptopropionate, or any mixture thereof, more preferably the chain-transfer agent used in step (ii) is methyl 3-mercaptopropionate.

23. The process of any one of embodiments 18 to 22, wherein step (ii) is carried out at a temperature of 35° C. to 73° C., preferably 40° C. to 70° C., more preferably 50° C. to 60° C.

24. The process of any one of embodiments 18 to 23, wherein step (ii) is carried out for a time of 5 to 40 hours, preferably 12 to 36 hours, more preferably 15 to 30 hours.

25. The process of any one of embodiments 18 to 24, wherein the average number of the structural unit A′ derived from monomer A in the polymer from step (ii) is in the range from 10 to 50, preferably in the range from 10 to 30, more preferably in the range from 12 to 18; and
the average number of the structural unit derived from monomer C in the polymer from step (ii) is in the range from 1 to 10, preferably in the range from 1 to 7, more preferably in the range from 1 to 4.

The polymer of the present invention and the polymer prepared by the processes of the present invention have improved antibacterial effects and can be prepared from raw materials that are easily obtainable, preferably obtainable from natural plants. In particular, the polymer of the present invention and the polymer prepared by the processes of the present invention have further improved antibacterial effects over antibacterial raw materials occurring in the nature and antibacterial polymers prepared merely from antibacterial tertiary amine monomers and without moiety B′ of the invention or prepared from other monomers such as 2-Hydroxyethyl methacrylate. In addition, the polymer of the present disclosure and the polymer prepared by the processes of the present disclosure are less allergenicity and show better safety than traditional biocides.

### DETAILED DESCRIPTION OF THE INVENTION

Unless defined otherwise, all technical and scientific terms used herein have the meaning commonly understood by a person skilled in the art to which the invention belongs. As used herein, the following terms have the meanings ascribed to them below, unless specified otherwise.

The articles “a”, “an” and “the” mean one or more of the species designated by the term following said article.

In the context of the present disclosure, any specific values mentioned for a feature (comprising the specific values mentioned in a range as the end point) can be recombined to form a new range.

In the context of the present disclosure, the term “(meth)acrylate” means a compound having a structure as follows:

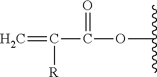

wherein R is H or methyl.

Further embodiments of the present invention are discernible from the claims, the description, and the examples. It will be understood that the aforementioned and hereinbelow still to be elucidated features of the subject matter of the present invention are utilizable not only in the particular combination indicated, but also in other combinations without leaving the realm of the present invention.

### Monomer A

In the present invention, monomer A is a monomer contains a nitrogen atom and a polymerizable carbon-carbon double bond. In an embodiment of the invention, the nitrogen atom in monomer A is substituted with one or two C₁₋₁₀ alkyl groups, preferably the nitrogen atom in monomer A is substituted with one or two groups selected from a group consisting of methyl, ethyl, propyl, butyl, and pentyl, more preferably the nitrogen atom in monomer A is a tertiary nitrogen atom.

Suitably, the polymerizable carbon-carbon double bond of monomer A may be selected from those found in the following functional groups: allyl, vinyl, acrylate, methacrylate, acryloxy, methacryloxy, acetylenyl, and the like; preferably, the polymerizable carbon-carbon double bond of monomer A may be selected from those found in acrylate, methacrylate, acryloxy, methacryloxy.

For the polymer of the present invention, examples of monomer A include, but are not limited to: (di-C₁₋₅alkyl-amino)C₁₋₅alkyl (meth)acrylate and (C₁₋₅alkyl-amino)C₁₋₅alkyl (meth)acrylate, such as N,N-dimethylaminomethyl (meth)acrylate, N,N-dimethylaminoethyl(meth)acrylate, 3-(N,N-dimethylamino)propyl(meth)acrylate, 4-(N,N-dimethylamino)butyl(meth)acrylate, (N,N-dimethylamino)-t-butyl(meth)acrylate, 2-(N,N-diethylamino)ethyl(meth)acrylate, 3-(N,N-diethylamino)propyl(meth)acrylate, 4-(N,N-diethylamino)butyl(meth)acrylate, 2-(N,N-dipropylamino)ethyl(meth)acrylate, 3-(N,N-dipropylamino)propyl(meth)acrylate, 4-(N,N-dipropylamino)butyl(meth)acrylate, and the like.

In an preferable embodiment of the invention, monomer A is selected from (di-C₁₋₃alkyl-amino)C₁₋₃alkyl (meth)acrylate and (C₁₋₃alkyl-amino)C₁₋₃alkyl (meth)acrylate, more preferably, monomer A is N,N-dimethylaminomethyl (meth)acrylate and/or N,N-dimethylaminoethyl (meth)acrylate.

Preferably, for the polymer of the present invention, monomer A is hydrophilic.

### Compound B

Moiety B′ of the polymer of the present invention is derived from compound B, wherein compound B is selected from a group consisting of bicyclic monoterpenes, monocyclic monoterpenes, acyclic monoterpenes, and C₁₋₁₀ alkyl-substituted phenol.

Bicyclic monoterpene is selected from pinene-based compounds containing hydroxy, carene-based compounds containing hydroxy, chrysanthanol, and fenchol.

As monocyclic monoterpenes suitable for being used as compound B, examples include, but are not limited to: α-terpineol, β-terpineol, γ-terpineol, and menthol. Preferably, the monocyclic monoterpene suitable for being used as compound B is menthol.

As acyclic monoterpenes suitable for being used as compound B, examples include, but are not limited to: geraniol, nerol, citronellol, dihydro-linalool, linalool, ethyl linalool, myrcenol, dihydro-myrcenol, hydroxycitronellal, and a stereoisomer thereof.

Preferably, acyclic monoterpenes suitable for being used as compound B is geraniol, nerol, and citronellol, more preferably citronellol.

As C₁₋₁₀ alkyl-substituted phenol suitable for being used as compound B, examples include, but are not limited to: phenols substituted with one or more of, such as two or three of groups selected from methyl, ethyl, propyl, butyl, pentyl, hexyl, heptyl, octyl, nonyl and decyl. Preferably, C₁₋₁₀ alkyl-substituted phenol suitable for being used as compound B is selected from thymol and/or carvacrol.

Preferably, compound B used for the present invention carries a OH group.

It is preferably that compound B is obtained from natural plants. For example, compound B is preferably selected from a group consisting of citronellol, menthol, thymol, and carvacrol. More preferably, compound B is citronellol, menthol, thymol, or carvacrol; more preferably, compound B is menthol or thymol.

As is used herein, moiety B′ derived from compound B can be determined b a skilled person. For example, when compound B is menthol, the moiety B′ may be

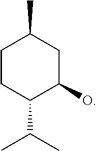

### Polymer

One aspect of the present invention relates to a polymer, containing a structural unit A′ derived from monomer A and a moiety B′ derived from compound B.

The polymer of the present invention may be prepared by any appropriate process selected by a skilled person according to practical applications. For example, to prepare the polymer of the invention, compound B may be modified to a compound B-based initiator, or compound B may be modified to a monomer C containing a polymerizable carbon-carbon double bond and the moiety B′, wherein moiety B′ is incorporated into the polymer via the compound B-based initiator and/or monomer C.

In an embodiment of the invention, the polymer is formed by atom transfer radical polymerization of monomer A, and moiety B′ is positioned at the end of the polymer, wherein the average number of structural unit A′ in the polymer is in the range from 5 to 150, preferably in the range from 5 to 120, such as in the range from 8 to 53, or in the range from 8 to 52, or in the range from 6 to 110.

In an embodiment, the polymer is formed by radical polymerization of monomer A and monomer C containing a polymerizable carbon-carbon double bond and a moiety B′ derived from a compound B,
wherein the average number of structural unit A′ in the polymer is in the range from 10 to 50, preferably in the range from 10 to 30, more preferably in the range from 12 to 18; and
the average number of the structural unit derived from monomer C is in the range from 1 to 10, preferably in the range from 1 to 7, more preferably in the range from 1 to 4.

Preferably, the formed polymer is a random copolymer.

In a preferable embodiment, the present invention relates to a polymer, containing a structural unit A′ derived from a monomer A and a moiety B′ derived from a compound B, wherein:
monomer A is selected from (di-C₁₋₅alkyl-amino)C₁₋₅alkyl (meth)acrylate and (C₁₋₅alkyl-amino)C₁₋₅alkyl (meth)acrylate, and compound B is selected from a group consisting of citronellol, menthol, thymol, and carvacrol.

In a preferable embodiment, the present invention relates to a polymer, containing a structural unit A′ derived from a monomer A and a moiety B′ derived from a compound B, wherein:
monomer A is selected from (di-C₁₋₃alkyl-amino)C₁₋₃alkyl (meth)acrylate and (C₁₋₃alkyl-amino)C₁₋₃alkyl (meth)acrylate, and compound B is selected from a group consisting of citronellol, menthol, thymol, and carvacrol.

In a preferable embodiment, the present invention relates to a polymer, containing a structural unit A′ derived from a monomer A and a moiety B′ derived from a compound B, wherein:
monomer A is N,N-dimethylaminomethyl (meth)acrylate and/or
N,N-dimethylaminoethyl (meth)acrylate, and
compound B is menthol, thymol or carvacrol.

In a preferable embodiment, the present invention relates to a polymer, containing a structural unit A′ derived from a monomer A and a moiety B′ derived from a compound B, wherein:
monomer A is selected from (di-C₁₋₅alkyl-amino)C₁₋₅alkyl (meth)acrylate and (C₁₋₅alkyl-amino)C₁₋₅alkyl (meth)acrylate, and
compound B is selected from a group consisting of citronellol, menthol, thymol, and carvacrol,
wherein the polymer is formed by atom transfer radical polymerization of monomer A, and moiety B′ is positioned at the end of the polymer, wherein the average number of structural unit A′ in the polymer is in the range from 5 to 150, preferably in the range from 5 to 120, such as in the range from 8 to 53, or in the range from 8 to 52, or in the range from 9 to 98.

In a preferable embodiment, the present invention relates to a polymer, containing a structural unit A′ derived from a monomer A and a moiety B′ derived from a compound B, wherein:
monomer A is selected from (di-C₁₋₃alkyl-amino)C₁₋₃alkyl (meth)acrylate and (C₁₋₃alkyl-amino)C₁₋₃alkyl (meth)acrylate, and
compound B is selected from a group consisting of citronellol, menthol, thymol, and carvacrol.
wherein the polymer is formed by atom transfer radical polymerization of monomer A, and moiety B′ is positioned at the end of the polymer, wherein the average number of structural unit A′ in the polymer is in the range from 5 to 150, preferably in the range from 5 to 120, such as in the range from 8 to 53, or in the range from 8 to 52, or in the range from 9 to 98.

In a preferable embodiment, the present invention relates to a polymer, containing a structural unit A′ derived from a monomer A and a moiety B′ derived from a compound B, wherein:
monomer A is N,N-dimethylaminomethyl (meth)acrylate and/or
N,N-dimethylaminoethyl (meth)acrylate, and
compound B is compound B is menthol, thymol or carvacrol.
wherein the polymer is formed by atom transfer radical polymerization of monomer A, and moiety B′ is positioned at the end of the polymer, wherein the average number of structural unit A′ in the polymer is in the range from 5 to 150, preferably in the range from 5 to 120, such as in the range from 8 to 53, or in the range from 8 to 52, or in the range from 9 to 98.

In a preferable embodiment, the present invention relates to a polymer, containing a structural unit A′ derived from a monomer A and a moiety B′ derived from a compound B, wherein:
monomer A is selected from (di-C₁₋₅alkyl-amino)C₁₋₅alkyl (meth)acrylate and (C₁₋₅alkyl-amino)C₁₋₅alkyl (meth)acrylate, and
compound B is selected from a group consisting of citronellol, menthol, thymol, and carvacrol,
wherein compound B is modified to a monomer C containing a polymerizable carbon-carbon double bond and the moiety B′ derived from a compound B,
wherein the polymer is formed by radical polymerization of monomer A and monomer C,
wherein the average number of structural unit A′ in the polymer is in the range from 10 to 50, preferably in the range from 10 to 30, more preferably in the range from 12 to 18; and
the average number of the structural unit derived from monomer C is in the range from 1 to 10, preferably in the range from 1 to 7, more preferably in the range from 1 to 4, preferably, the polymer is a random copolymer.

In a preferable embodiment, the present invention relates to a polymer, containing a structural unit A′ derived from a monomer A and a moiety B′ derived from a compound B, wherein:
monomer A is selected from (di-C₁₋₃alkyl-amino)C₁₋₃alkyl (meth)acrylate and (C₁₋₃alkyl-amino)C₁₋₃alkyl (meth)acrylate, and
compound B is selected from a group consisting of citronellol, menthol, thymol, and carvacrol,
wherein compound B is modified to a monomer C containing a polymerizable carbon-carbon double bond and the moiety B′ derived from a compound B,
wherein the polymer is formed by radical polymerization of monomer A and monomer C,
wherein the average number of structural unit A′ in the polymer is in the range from 10 to 50, preferably in the range from 10 to 30, more preferably in the range from 12 to 18; and
the average number of the structural unit derived from monomer C is in the range from 1 to 10, preferably in the range from 1 to 7, more preferably in the range from 1 to 4, preferably, the polymer is a random copolymer.

In a preferable embodiment, the present invention relates to a polymer, containing a structural unit A′ derived from a monomer A and a moiety B′ derived from a compound B, wherein:
monomer A is N,N-dimethylaminomethyl (meth)acrylate and/or
N,N-dimethylaminoethyl (meth)acrylate, and
compound B is compound B is menthol, thymol or carvacrol,
wherein compound B is modified to a monomer C containing a polymerizable carbon-carbon double bond and the moiety B′ derived from a compound B,
wherein the polymer is formed by radical polymerization of monomer A and monomer C,
wherein the average number of structural unit A′ in the polymer is in the range from 10 to 50, preferably in the range from 10 to 30, more preferably in the range from 12 to 18; and
the average number of the structural unit derived from monomer C is in the range from 1 to 10, preferably in the range from 1 to 7, more preferably in the range from 1 to 4, preferably, the polymer is a random copolymer.

### Process A (Corresponding to Above Embodiments 10 to 17)

One aspect of the present invention relates to a process A of preparing the polymer of the invention, comprising:
(1) modifying compound B to prepare a compound B-based initiator; and
(2) polymerizing monomer A via atom transfer radical polymerization using the compound B-based initiator, to obtain the polymer.

Step (1) of process A of the present invention may be carried out by a skilled person according to practical applications, provided that a compound B-based initiator will be obtained.

In a preferable embodiment of the invention, step (1) of process A of the present invention is carried out by modifying compound B with an agent having formula RCOX, wherein X is a halogen, preferable Cl or Br; R is a C₁₋₆ alkyl substituted with one halogen atom, such as methyl, ethyl, propyl, butyl, pentyl, hexyl, substituted with one halogen atom, preferably the halogen atom is Cl or Br, more preferably the agent is α-bromoisobutyryl bromide.

Solvent may be used in step (1) of process A of the present invention. Examples of suitable solvent used in step (1) of process A include, but are not limit to: halogenated hydrocarbons such as dichloromethane, 1,2-dichloroethane, chloroform and chlorobenzene. Particular preference is given to halogenated hydrocarbons such as dichloromethane, and 1,2-dichloroethane.

Preferably, in step (1) of process A of the present invention wherein compound B is modified with an agent having formula RCOX, the solvent is halogenated hydrocarbons such as dichloromethane, 1,2-dichloroethane, chloroform or chlorobenzene, preferably the solvent is dichloromethane.

Step (1) of process A of the present invention preferably is carried out in the presence of an acid-binding agent. Suitable acid-binding agent for step (1) of process A may be chosen by a skilled person according to practical applications. Preferably, examples of the acid-binding agents suitable for step (1) of process A may include trialkyl amine, for example tri-C₁-C₁₀-alkyl amine, such as trimethylamine, triethylamine, tripropylamine, tributylamine, tripentylamine, trihexylamine, triheptylamine, trioctylamine, more preferably triethylamine.

Step (1) of process A of the present invention preferably is carried out in the presence of a catalyst. Suitable catalyst for step (1) of process A may be chosen by a skilled person according to practical applications. Preferably, examples of the catalysts suitable for step (1) of process A may include an organic basic compound, with examples comprising, but being not limit to: guanidine, 1,1-dimethylguanidine, 1,1,3,3-tetramethylguanidine, 2-aminopyridine, 3-aminopyridine, 4-aminopyridine, 2-dimethylaminopyridine, 4-dimethylaminopyridine, 2-diethylaminopyridine, 2-aminomethyl)pyridine, 2-amino-3-methylpyridine, 2-amino-4-methylpyridine, 2-amino-5-methylpyridine, 2-amino-6-methylpyridine, 3-aminoehtylpyridine, 4-aminoehylpyridine, 3-aminopyrrolidine, piperazine, N-(2-aminoethyl)piperazine, N-(2-aminoethyl)piperidine, 4-amino-2,2,6,6-tetramethylpiperidine, 4-piperidinopiperidine, 2-imimopiperidine, 1-(2-aminoethyl)pyrrolidine, pyrazole, 3-amino-5-methylpyrazole, 5-aminomethyl-1-p-tolylpyrazole, pyrazine, 2-aminomethyl)-5-methylpyrazine, pyrimidine, 2,4-diaminopyrimidine, 4,6-dihydroxypyrimidine, 2-pyrazoline, 3-pyrazoline, N-aminomorpholine, and N-(2-aminoethyl)morpholine.

In a preferable embodiment of the invention, step (1) of process A of the present invention is carried out in the presence of a catalyst system containing both the acid-binding agent and the catalyst preferably in a molar ratio of the acid-binding agent to the catalyst of 1:1.5 to 1.5:1, preferably 1:1.2 to 1.2:1, more preferably 1:1.

Preferably, the catalyst system contains an acid-binding agent trialkyl amine and a catalyst organic basic compound, preferably contains a tri-C₁-C₁₀-alkyl amine and a dialkylaminopyridine, more preferably contains triethylamine and 4-dimethylaminopyridine, preferably in a molar ratio of the trialkyl amine to the organic basic compound of 1:1.5 to 1.5:1, preferably 1:1.2 to 1.2:1, more preferably 1:1.

The temperature for carrying out step (1) of process A of the present invention may be determined by a skilled person according to practical applications. For example, step (1) of process A of the present invention may be carried out at a temperature in the range from 10° C. to 50° C., preferably in the range from 10° C. to 40° C., more preferably in the range from 10 to 30° C., such as at room temperature (RT, about 23° C.).

The time for carrying out step (1) of process A of the present invention may be determined by a skilled person according to practical applications. For example, step (1) of process A of the present invention may be carried out for a period in the range from 5 to 30 hours, preferably in the range from 8 to 20 hours, more preferably in the range from 6 to 18 hours.

Preferably, step (1) of process A of the present invention is carried out in an inert atmosphere such as argon or nitrogen gas, more preferably nitrogen gas.

In step (2) of process A of the present invention, monomer A is polymerized via atom transfer radical polymerization, using the compound B-based initiator obtained from step (1) as the initiator, to obtain the polymer of the present invention.

In step (2) of process A of the present invention, the amount of the initiator (i.e., the compound B-based initiator obtained from step (1)) can be present in a molar ratio of from 1:5 to 1:150, preferably from 1:5 to 1:100, more preferably from 1:5 to 1:50, most preferably from 1:5 to 1:35, relative to monomer A.

Step (2) of process A of the present invention preferably is carried out in the presence of a catalyst system containing a catalyst and a ligand. Preferably, the catalyst is a transition metal compound.

Preferably, examples of the transition metal compound include, but are not limited to those of the formula Mⁿ⁺X′ₙ, wherein Mⁿ⁺ may be selected from the group consisting of Mn³⁺, Mn⁴⁺, Re²⁺, Re³⁺, Fe²⁺, Fe³⁺, Ru²⁺, Ru³⁺, Co⁺, Co²⁺, Rh³⁺, Rh⁴⁺, Ni⁰, Ni⁺, Cu¹⁺, Cu²⁺, Zn⁺, Zn²⁺, Cr²⁺, Cr³⁺, Mo⁰, Mo⁺, Mo²⁺, Mo³⁺, W²⁺, W³⁺, V²⁺, V³⁺, Au⁺, Au²⁺, Ag⁺, and Ag²⁺; X′ may be selected from the group consisting of halogen and CN, preferably X′ is halogen, such as F, Cl and Br, more preferably Br; and n may be in the range from 0 to 4, preferably in the range from 1 to 4, more preferably in the range from 1 to 3. Preferably, the transition metal compound used in step (2) of process A of the present invention is CuBr.

Suitable ligands for use in step (2) of process A of the present invention may be determined by a skilled person according to practical applications. Examples of suitable ligands for use in step (2) of process A of the present invention include, but are not limit to, polyamines, such as ethylenediamine, diethylenetriamine, and propylenediamine, which may be substituted from one to four times on the amino nitrogen atom with a C₁-C₆ alkyl group (such as methyl, ethyl, propyl, butyl, pentyl, or hexyl) or a carboxymethyl group; aminoethanol and aminopropanol, which may be substituted on the oxygen and/or nitrogen atom with a C₁-C₆ alkyl group; ethylene glycol and propylene glycol, which may be substituted on the oxygen atoms with a C₁-C₆ alkyl group.

Preferably, the ligand used in step (2) of process A of the present invention is N,N,N′,N″,N″-pentamethyldiethylenetriamine.

For the purposes of the present invention, if there is a material that is suitable for being used as monomer A and as the ligand, such material will be classified as monomer A and will not be classified into the scope of the ligand.

The catalyst and the ligand may be added into the reaction system simultaneously, or they may be added into the reaction system separately. In a preferable embodiment of the invention, the catalyst is added into the reaction system after the ligand.

In the catalyst system used in step (2) of process A of the present invention, the molar ratio of the ligand to the catalyst can be determined by a skilled person according to practical applications. Preferably, the ligand is in molar excess relative to the catalyst.

The molar ratio of the initiator (i.e., the compound B-based initiator obtained from step (1)) to the catalyst can be determined by a skilled person according to practical applications, and may be from 20:1 to 1:20, preferably from 10:1 to 1:10, more preferably from 5:1 to 1:5, and most preferably from 1:1 to 1:2.

Preferably, step (2) of process A of the present invention is carried out in the presence of a solvent. Examples of the solvent include, but are not limited to, polar solvents which are inert under the reaction conditions, for example C₁-C₄-alkanols such as methanol, ethanol, n-propanol or isopropanol; dialkyl ethers such as diethyl ether, diisopropyl ether or methyl tert-butyl ether; cyclic ethers such as dioxane or tetrahydrofuran; acetonitrile, carboxamides such as N,N-dimethyl formamide, N,N-dimethyl acetamide or N-methylpyrrolidinone; or a mixture thereof.

Preferred solvent in step (2) of process A of the present invention may be C₁-C₄-alkanols such as methanol, ethanol, n-propanol or isopropanol, especially methanol.

The temperature for carrying out step (2) of process A of the present invention may be determined by a skilled person according to practical applications. For example, step (2) of process A of the present invention may be carried out at a temperature of 35° C. to 65° C., preferably 40° C. to 60° C., more preferably 45° C. to 55° C.

The time for carrying out step (2) of process A of the present invention may be determined by a skilled person according to practical applications. For example, step (2) of process A of the present invention may be carried out for a period of 4 to 40 hours, preferably 4 to 30 hours, more preferably 4 to 24 hours.

Preferably, step (2) of process A of the present invention is carried out in an inert atmosphere such as argon or nitrogen gas, more preferably nitrogen gas.

Preferably, with step (2) of process A of the present invention, the polymerization degree of the polymer from step (2) is in a range of 10 to 150, preferably in a range of 10 to 120, more preferably in a range of 10 to 100.

In an embodiment, the present invention relates to a process A of preparing a polymer, comprising:
(1) modifying compound B to prepare a compound B-based initiator; and
(2) polymerizing monomer A via atom transfer radical polymerization using the compound B-based initiator, to obtain the polymer;
   wherein monomer A is selected from (di-C₁₋₅alkyl-amino)C₁₋₅alkyl (meth)acrylate and (C₁₋₅alkyl-amino)C₁₋₅alkyl (meth)acrylate, preferably (di-C₁₋₃alkyl-amino)C₁₋₃alkyl (meth)acrylate and (C₁₋₃alkyl-amino)C₁₋₃alkyl (meth)acrylate, more preferably monomer A is N,N-dimethylaminomethyl (meth)acrylate and/or N,N-dimethylaminoethyl (meth)acrylate,
   wherein compound B is citronellol, menthol, thymol, or carvacrol,
   wherein step (1) is carried out by modifying compound B with an agent having formula RCOX, wherein X is a halogen, preferable Cl or Br; R is a C₁₋₆ alkyl substituted with one halogen atom, such as methyl, ethyl, propyl, butyl, pentyl, hexyl, substituted with one halogen atom, preferably the halogen atom is Cl or Br, more preferably the agent is α-bromoisobutyryl bromide.

In an embodiment, the present invention relates to a process A of preparing a polymer, comprising:
(1) modifying compound B to prepare a compound B-based initiator; and
(2) polymerizing monomer A via atom transfer radical polymerization using the compound B-based initiator, to obtain the polymer;
   wherein monomer A is N,N-dimethylaminomethyl (meth)acrylate and/or N,N-dimethylaminoethyl (meth)acrylate,
   wherein compound B is menthol, thymol or carvacrol,
   wherein step (1) is carried out by modifying compound B with an agent having formula RCOX, wherein X is a halogen, preferable Cl or Br; R is a C₁₋₆ alkyl substituted with one halogen atom, such as methyl, ethyl, propyl, butyl, pentyl, hexyl, substituted with one halogen atom, preferably the halogen atom is Cl or Br, more preferably the agent is α-bromoisobutyryl bromide.

In an embodiment, the present invention relates to a process A of preparing a polymer, comprising:
(1) modifying compound B to prepare a compound B-based initiator; and
(2) polymerizing monomer A via atom transfer radical polymerization using the compound B-based initiator, to obtain the polymer;
   wherein monomer A is N,N-dimethylaminomethyl (meth)acrylate and/or N,N-dimethylaminoethyl (meth)acrylate,
   wherein compound B is menthol, thymol or carvacrol,
   wherein step (1) is carried out by modifying compound B with an agent having formula RCOX, wherein X is a halogen, preferable Cl or Br; R is a C₁₋₆ alkyl substituted with one halogen atom, such as methyl, ethyl, propyl, butyl, pentyl, hexyl, substituted with one halogen atom, preferably the halogen atom is Cl or Br, more preferably the agent is α-bromoisobutyryl bromide,
   wherein the atom transfer radical polymerization is carried out in the presence of a catalyst system comprising CuBr and N,N,N′,N″,N″-pentamethyldiethylenetriamine.

### Process B (Corresponding to Above Embodiments 18 to 25)

One aspect of the present invention relates to a process B of preparing a polymer, comprising:
(i) modifying a compound B to prepare a monomer C containing a polymerizable carbon-carbon double bond and a moiety B′ derived from compound B; and
(ii) polymerizing the monomer C and monomer A via radical polymerization, in the presence of an initiator and a chain-transfer agent, to obtain the polymer;
   wherein monomer A and compound B are described above.

In a preferable embodiment of the invention, step (i) is carried out by modifying compound B with an unsaturated carbonyl halide, preferably acryloyl chloride or methacryloyl chloride, more preferably methacryloyl chloride.

Solvent may be used in step (i) of process B of the present invention. Examples of the solvent used in step (i) of process B include, but are not limit to: halogenated hydrocarbons such as dichloromethane, 1,2-dichloroethane, chloroform and chlorobenzene. Particular preference is given to dichloromethane and 1,2-dichloroethane.

Preferably, in step (i) of process B of the present invention wherein compound B is modified with an unsaturated carbonyl halide, preferably acryloyl chloride or methacryloyl chloride, more preferably methacryloyl chloride, the solvent is dichloromethane, 1,2-dichloroethane, chloroform or chlorobenzene, preferably dichloromethane.

Preferably, step (i) of process B of the present invention may be carried out in the presence of a trialkyl amine, for example tri-C₁-C₁₀-alkyl amine, such as trimethylamine, triethylamine, tripropylamine, tributylamine, tripentylamine, trihexylamine, triheptylamine, trioctylamine, more preferably triethylamine. The amount of trialkyl amine in step (i) of process B of the present invention can be determined by a skilled person according to practical applications.

The temperature for carrying out step (i) of process B of the present invention may be determined by a skilled person according to practical applications. For example, step (i) of process B of the present invention may be carried out at a temperature in the range from 10° C. to 50° C., preferably in the range from 10° C. to 40° C., more preferably in the range from 10 to 30° C., such as at room temperature (RT, about 23° C.).

The time for carrying out step (i) of process B of the present invention may be determined by a skilled person according to practical applications. For example, step (i) of process B of the present invention may be carried out for a time in the range from 5 to 30 hours, preferably in the range from 5 to 20 hours, more preferably in the range from 6 to 18 hours.

Preferably, step (i) of process B of the present invention is carried out in an inert atmosphere such as argon or nitrogen gas, more preferably nitrogen gas.

With step (i) of process B, monomer C containing a polymerizable carbon-carbon double bond and a moiety B′ derived from compound B is obtained.

In step (ii) of process B of the present invention, monomer C is polymerized with monomer A via radical polymerization, in the presence of an initiator and a chain-transfer agent, to obtain the polymer.

In step (ii) of process B of the present invention, useful initiators may include peroxides and azo compounds.

The initiators are used in customary amounts, for example in amounts from 0.001% to 5% by weight and preferably from 0.01% to 1% by weight, based on the monomers to be polymerized.

Useful peroxides are for example hydrogen peroxide, acetylacetone peroxide, methyl ethyl ketone peroxide, tert-butyl hydroperoxide, cumene hydroperoxide, tert-amyl perpivalate, tert-butyl perpivalate, tert-butyl perneohexanoate, tert-butyl perisobutyrate, tert-butyl per-2-ethylhexanoate, tert-butyl perisononanoate, tert-butyl permaleate, tert-butyl perbenzoate, di(2-ethylhexyl) peroxydicarbonate, dicyclohexyl peroxydicarbonate, di(4-tert-butylcyclohexyl) peroxydicarbonate, dimyristyl peroxydicarbonate, diacetyl peroxydicarbonate, allyl peresters, cumyl peroxyneodecanoate, tert-butyl per-3,5,5-tri-methylhexanoate, acetylcyclohexylsulfonyl peroxide, dilauryl peroxide, dibenzoyl peroxide, tert-amyl perneodecanoate, and persulfates.

Preferred initiators are azo compounds, examples being 2,2′-azobisisobutyronitrile,
2,2′-azobis(2,4-dimethylvaleronitrile) and
2,2′-azobis(4-methoxy-2,4-dimethyl-valeronitrile),
2,2′-azobis-{2-[1-(2-hydroxyethyl)-2-imidazolin-2-yl]propane}dihydrochloride,
2,2′-azobis-(2-amidinopropane) dihydrochloride,
2,2′-azobis[2-(2-imidazolin-2-yl)propane]dihydrochloride and
2,2′-azobis[2-(5-methyl-2-imidazolin-2-yl)propane]dihydrochloride. Preferably
2,2′-azobisisobutyronitrile.

Preferably, the initiator used in step (ii) of process B of the present invention is an azo type initiator, preferably 2,2-Azobisisobutyronitrile.

Suitable chain-transfer agents for use in step (ii) of process B of the present invention can include mercaptans such as n-octyl mercaptan, n-dodecyl mercaptan, t-octyl mercaptan, tetradecyl mercaptan, hexadecyl mercaptan, β-mercaptoethanol, 3-mercaptopropanol, tert-nonyl mercaptan, tert-dodecyl mercaptan, 6-mercaptomethyl-2-methyl-2-octanol, 4-mercapto-3-methyl-1-butanol, 2-phenyl-1-mercapto-2-ethanol, thioglycolic acid, methyl thioglycolate, n-butyl thioglycolate, i-octyl thioglycolate, dodecyl thioglycolate, octadecyl thioglycolate, methyl 3-mercaptopropionate, butyl 3-mercaptopropionate, i-octyl 3-mercaptopropionate, i-decyl 3-mercaptopropionate, dodecyl 3-mercaptopropionate, octadecyl 3-mercaptopropionate, or a mixture thereof. Preferably, the chain-transfer agent used step (ii) of process B of the present invention is Methyl 3-mercaptopropionate. The amount of the chain transfer agent used for step (ii) of process B of the present invention can be determined by a skilled person according to practical applications.

Preferably, step (ii) of process B of the present invention is carried out in the presence of a solvent. Examples of the solvent may include, but are not limited to esters. Examples of esters are, for example, n-butyl acetate, ethyl acetate. Preferably, the solvent used step (ii) of process B of the present invention is ethyl acetate.

The temperature for carrying out step (ii) of process B of the present invention may be determined by a skilled person according to practical applications. For example, step (ii) of process B of the present invention may be carried out at a temperature of 35° C. to 73° C., preferably 40° C. to 70° C., such as 50° C. to 60° C.

The time for carrying out step (ii) of process B of the present invention may be determined by a skilled person according to practical applications. For example, step (ii) of process B of the present invention may be carried out for a time for a time of 5 to 40 hours, more preferably 12 to 36 hours, such as 15 to 30 hours.

Preferably, step (ii) of process B of the present invention is carried out in an inert atmosphere such as argon or nitrogen gas, more preferably nitrogen gas.

Preferably, with step (ii) of process B of the present invention, the average number of the structural unit A′ derived from monomer A in the polymer from step (ii) is in a range of 10 to 50, preferably in a range of 10 to 30, more preferably in a range of 12 to 18; and the average number of the structural unit derived from monomer C in the polymer from step (ii) is in a range of 1 to 10, preferably in a range of 1 to 7, more preferably in a range of 1 to 4.

Preferably, the polymer from process B of the present invention is a random copolymer.

In an embodiment, the present invention relates to a process B of preparing a polymer, comprising:
(i) modifying a compound B to prepare a monomer C containing a polymerizable carbon-carbon double bond and a moiety B′ derived from compound B; and
(ii) polymerizing monomer C and monomer A via radical polymerization, in the presence of an initiator and a chain-transfer agent, to obtain the polymer;
   wherein monomer A is selected from (di-C₁₋₅alkyl-amino)C₁₋₅alkyl (meth)acrylate and (C₁₋₅alkyl-amino)C₁₋₅alkyl (meth)acrylate, preferably (di-C₁₋₃alkyl-amino)C₁₋₃alkyl (meth)acrylate and (C₁₋₃alkyl-amino)C₁₋₃alkyl (meth)acrylate, more preferably A is N,N-dimethylaminomethyl (meth)acrylate and/or N,N-dimethylaminoethyl (meth)acrylate, and
   wherein compound B is selected from a group consisting of citronellol, menthol, thymol, and carvacrol, preferably, compound B is citronellol, menthol, thymol, or carvacrol,
   wherein step (i) is carried out by modifying compound B with an unsaturated carbonyl halide, preferably acryloyl chloride or methacryloyl chloride, more preferably methacryloyl chloride.

In an embodiment, the present invention relates to a process B of preparing a polymer, comprising:
(i) modifying a compound B to prepare a monomer C containing a polymerizable carbon-carbon double bond and a moiety B′ derived from compound B; and
(ii) polymerizing monomer C and monomer A via radical polymerization, in the presence of an initiator and a chain-transfer agent, to obtain the polymer;
   wherein monomer A is selected from (di-C₁₋₅alkyl-amino)C₁₋₅alkyl (meth)acrylate and (C₁₋₅alkyl-amino)C₁₋₅alkyl (meth)acrylate, preferably (di-C₁₋₃alkyl-amino)C₁₋₃alkyl (meth)acrylate and (C₁₋₃alkyl-amino)C₁₋₃alkyl (meth)acrylate, more preferably A is N,N-dimethylaminomethyl (meth)acrylate and/or N,N-dimethylaminoethyl (meth)acrylate, and
   wherein compound B is selected from a group consisting of citronellol, menthol, thymol, and carvacrol, preferably, compound B is citronellol, menthol, thymol, or carvacrol,
   wherein step (i) is carried out by modifying compound B with an unsaturated carbonyl halide, preferably acryloyl chloride or methacryloyl chloride, more preferably methacryloyl chloride,
   wherein the initiator used in step (ii) is an azo type initiator, preferably 2,2-Azobisisobutyronitrile; and
   wherein the chain-transfer agent used step (ii) is a mercaptan, preferably methyl 3-mercaptopropionate.

In an embodiment, the present invention relates to a process B of preparing a polymer, comprising:
(i) modifying a compound B to prepare a monomer C containing a polymerizable carbon-carbon double bond and a moiety B′ derived from compound B; and
(ii) polymerizing monomer C and monomer A via radical polymerization, in the presence of an initiator and a chain-transfer agent, to obtain the polymer;
   wherein monomer A is N,N-dimethylaminomethyl (meth)acrylate and/or N,N-dimethylaminoethyl (meth)acrylate, and
   wherein compound B is citronellol, menthol, thymol, or carvacrol,
   wherein step (i) is carried out by modifying compound B with an unsaturated carbonyl halide, preferably acryloyl chloride or methacryloyl chloride, more preferably methacryloyl chloride.
   wherein the initiator used in step (ii) is an azo type of initiator, preferably 2,2-Azobisisobutyronitrile; and
   wherein the chain-transfer agent used step (ii) is a mercaptan, preferably methyl 3-mercaptopropionate.

### EXAMPLES

The present invention will be better understood in view of the following non-limiting examples.

### Materials

Menthol, Guangdong Huaqingyuan Biotechnology Co., Ltd.
Thymol, Guangdong Huaqingyuan Biotechnology Co., Ltd.
Bromoisobutyryl bromide (BiBB), Aldrich
CuBr, Aldrich
N,N,N′,N″,N″-pentamethyldiethylenetriamine (PMDETA), Aldrich
2-(N,N-dimethylamino)ethyl methacrylate (DMAEMA), Aldrich
Gram-positive 2 bacteria (S. aureus, ATCC 25923), China Center of Industrial Culture, commercially available from Guangdong Huankai Microbial Sci.&Tech. Co., Ltd., Guangdong, China
methicillin-resistant Staphylococcus aureus (ATCC 43300), China Center of Industrial Culture, commercially available from Guangdong Huankai Microbial Sci.&Tech. Co., Ltd., Guangdong, China
Gram-negative bacteria (E. coli, ATCC 43894), China Center of Industrial Culture, commercially available from Guangdong Huankai Microbial Sci.&Tech. Co., Ltd., Guangdong, China.

### Measuring and Test Methods:

Method for Determining Number-Average Molecular Weight (g/mol), Polydispersity Index (PDI) and Polymerization Degree

Number-average molecular weight, PDI and polymerization degree were determined by ¹H NMR.

### Antibacterial Properties

### MIC Determination of Antibacterial Polymers

MIC (minimum inhibitory concentration) was used as an effective qualitative method of antibacterial ability assessment. MIC of antibacterial polymers were determined against S. aureus and E. coli by a serial dilution method. Bacteria LB agar plates were prepared from glycerol stock. Bacteria were inoculated with LB broth in an inoculation shaker at 200 rpm and 37° C., overnight. Bacteria suspension (40 μL) from overnight culture was transferred to fresh LB broth (4 mL) and inoculated in an inoculation shaker at 200 rpm and 37° C. to reach mid-exponential development phase. Bacteria suspension was then suspended in LB broth to a concentration of 5×10⁵ CFU mL⁻¹. Polymers were dissolved in LB broth to get a concentration of 5.0 mg mL⁻¹. Polymer solutions were serially diluted in a 96-well plate with LB broth. Bacteria suspensions were added to each well of the 96-well plate and then the mixed suspensions of polymers and bacteria were incubated for 24 h in an incubator at 37° C. MIC was determined with no visible growth at 600 nm by spectrophotometer. The MIC measurement was done in triplicate to confirm the value of MIC for each type of bacteria. Bacteria suspension without polymer was used as a positive control and LB broth without polymer and bacteria was used as a negative control.

### MBC Determination of Antibacterial Polymers

The MBC was defined as the lowest concentration of an antibacterial agent that kills bacteria in the planktonic culture. MBC of antibacterial polymers and control were determined against S. aureus and E. coli by the reported method in publication “Antibacterial and Bacterially Antiadhesive Cotton Fabrics Coated by Cationic Fluorinated Polymers. ACS Appl Mater Interfaces 2018, 10 (7), 6124-6136.”

### Example 1

### (1) Preparation of Menthol-Based Initiator

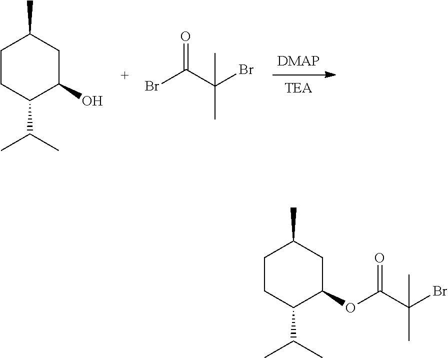

Menthol (10.296 g, 66 mmol) and 4-dimethylaminopyridine (16.28 g, 133 mmol) were dissolved in dichloromethane (200 mL). The resultant solution and triethylamine (TEA) were charged successively into a 500 mL three-neck flask with refluxing. Then the obtained system was mechanically stirred in an ice bath and with N₂ protection. A mixed liquid of Bromoisobutyryl bromide (16.4 mL, 133 mmol) diluted with dichloromethane was added dropwise into the system. After the addition is completed, the ice bath was removed and the reaction was continued for 12 hours at room temperature.

After the reaction is completed, bromate white solids produced from the reaction was firstly removed by suction filtration, the resultant filtrate was rotary evaporated, then dispersed with water, the resultant aqueous dispersion was extracted with ethyl ether (3×100 mL), and allowed to stand for phase separation. The upper organic phase was collected, and washed with 0.1 mol/L hydrochloric acid and saturated sodium bicarbonate solution successively. The resultant organic phase was dried overnight with anhydrous magnesium sulfate, filtrated, and rotary evaporated to obtain a crude product. The crude product was purified with a silica gel column using a mixture of n-hexane and ethyl acetate (n-hexane:ethyl acetate=98:2 V/V) as eluent. The purified product was concentrated via rotary evaporation to obtain a concentrated product. The concentrated product was dried in a vacuum oven for 12 hours at 40° C., to obtain a yellowish clear oil product (the menthol-based initiator, Yield 95%).

### (2) Preparation of Polymer Menthol-PDMAEMA

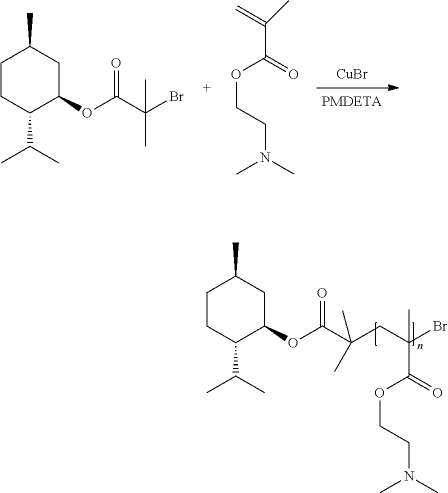

The menthol-based initiator obtained from step (1) (1 mmol, 0.305 g), 2-(N,N-dimethylamino)ethyl methacrylate (DMAEMA) (10 mmol, 1.57 g), N,N,N′,N″,N″-pentamethyldiethylenetriamine (2 mmol, 0.412 mL), and methanol (15 mL) were charged successively into a gas-tight Schlenk reaction tube under N₂ atmosphere. The resultant reaction system was freeze-degassed, then purified CuBr powder (0.288 g, 2 mmol) was add under N₂ atmosphere. After that, freeze-degassing was carried out for further three times to create an oxygen-free environment for an atom transfer radical polymerization system. Then the Schlenk reaction tube under N₂ atmosphere was placed into an oil bath of 50° C. for 6 hours with stirring. The reaction was quenched by passing air into the system under ice-water condition. The resultant product was rotary evaporated to remove solvent methanol, then was purified by a Neutral alumina column using tetrahydrofuran as eluent. The purified product was precipitated drop by drop in iced n-hexane. The precipitated product was allowed to stand for 30 minutes in low-temperature environment of from −20° C. to 0° C., then the supernatant was removed. The resultant product was dried in a vacuum oven for 6 hours at 50° C., to obtain a yellowish, viscous solid final polymer product (polymer Menthol-PDMAEMA₁₀).

### Example 2

### (i) Preparation of Menthyl Methacrylate

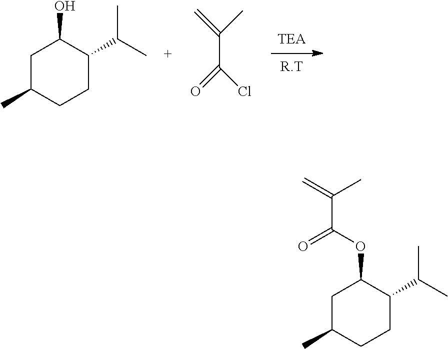

Menthol (66 mmol, 10.296 g) was dissolved in dichloromethane (100 mL). The resultant solution and triethylamine (99 mmol, 10 g) were charged successively into a 500 mL three-neck flask with refluxing. Then the resultant system was mechanically stirred in an ice bath and with N₂ protection. A mixed liquid of methacryloyl chloride (99 mmol, 10.35 g) diluted with dichloromethane (50 mL) was added dropwise into the system. After the addition is completed, the ice bath was removed and reaction was continued for 12 hours at room temperature.

After the reaction is completed, hydrochloride white solids produced from the reaction was firstly removed by suction filtration, the resultant filtrate was rotary evaporated, then washed with 0.1 mol/L hydrochloric acid and saturated sodium bicarbonate solution successively. The resultant organic phase was dried overnight with anhydrous magnesium sulfate, filtrated, and rotary evaporated to obtain a crude product. The crude product was purified with a silica gel column using a mixture of n-hexane and ethyl acetate (n-hexane:ethyl acetate=95:5 V/V) as eluent. The purified product was concentrated via rotary evaporation to obtain a concentrated product. The concentrated product was dried in a vacuum oven for 2 hours at 40° C., to obtain a yellowish clear oil product (menthyl methacrylate, Yield 93%).

### (ii) Preparation of Random Polymer of Menthyl Methacrylate and DMAEMA (PM-r-D)

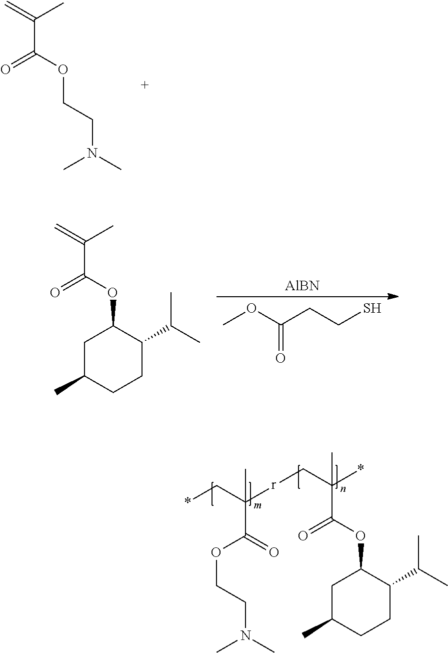

Menthyl methacrylate from step (i) (1 mmol, 0.224 g) and 2-(N,N-dimethylamino)ethyl methacrylate (DMAEMA) (20 mmol, 3.14 g) were charged into a one-neck flask, and dissolved by adding an amount of ethyl acetate (20 mL) with stirring to obtain a homogeneous solution. Then 2,2-azobisisobutyronitrile (0.1 mmol, 0.0164 g) and methyl 3-mercaptopropionate (1 mmol, 0.108 g) were added into the solution. The resultant reaction system was sealed with a rubber stopper connecting to a N₂-bubbling apparatus. Oxygen in the reaction system was removed by bubbling N₂ into the system for 30 minutes. Then the N₂-bubbling was stopped and the N₂-bubbling apparatus was removed. The reaction was then carried out for 24 hours at a temperature of about 55° C. The reaction was quenched by liquid nitrogen and the solvent was removed by rotary evaporation. The resultant product was precipitated in n-hexane, and then allowed to stand in refrigerator for 2 hours. The formed supernatant was removed. The resultant product was dried in a vacuum oven for 12 hours at 40° C., to obtain an oily or lumpy polymer product (PM-r-D₁₇, Yield 71%).

### Example 3

### (1) Preparation of Thymol-Based Initiator

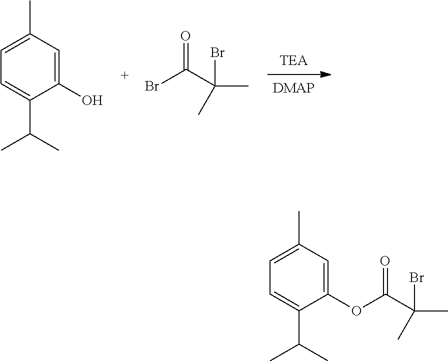

Thymol (9.9 g, 66 mmol) and 4-dimethylaminopyridine (16.28 g, 133 mmol) were dissolved in dichloromethane (200 mL). The resultant solution and triethylamine were charged successively into a 500 mL three-neck flask with refluxing. Then the resultant system was mechanically stirred in an ice bath and with N₂ protection. A mixed liquid of Bromoisobutyryl bromide (16.4 mL, 133 mmol) diluted with dichloromethane was added dropwise into the system. After the addition is completed, the ice bath was removed and the reaction was continued for 12 hours at room temperature.

After the reaction is completed, bromate white solids produced from the reaction was firstly removed by suction filtration, the resultant filtrate was rotary evaporated, then dispersed with water, the resultant aqueous dispersion was extracted with ethyl ether (3×100 mL), and allowed to stand for phase separation. The upper organic phase was collected, and washed with 0.1 mol/L hydrochloric acid and saturated sodium bicarbonate solution successively. The resultant organic phase was dried overnight with anhydrous magnesium sulfate, filtrated, and rotary evaporated to obtain a crude product. The crude product was purified with a basic alumina column using a mixture of petroleum ether and ethyl acetate (petroleum ether:ethyl acetate=98:2 V/V) as eluent. The purified product was concentrated via rotary evaporation to obtain a concentrated product. The concentrated product was dried in a vacuum oven for 12 hours at 40° C., to obtain a yellowish clear liquid product (the thymol-based initiator, Yield 95%).

### (2) Preparation of Polymer Thymol-PDMAEMA

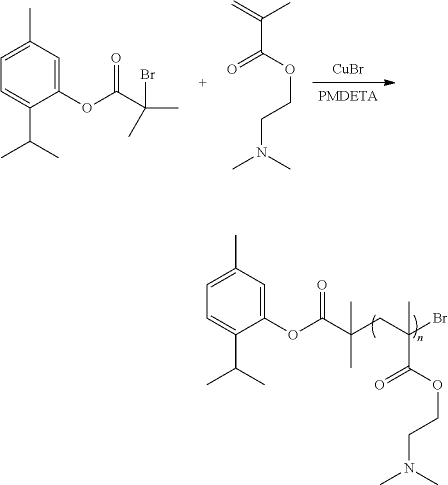

The thymol-based initiator obtained from step (1) (0.5 g, 1.67 mmol), 2-(N,N-dimethylamino)ethyl methacrylate (DMAEMA) (2.8 mL, 16.6 mmol), N,N,N′,N″,N″-pentamethyldiethylenetriamine (0.687 mL, 3.33 mmol), and methanol (15 mL) were charged successively into a gas-tight Schlenk reaction tube under N₂ atmosphere. The resultant reaction system was freeze-degassed, then purified CuBr powder (0.476 g, 3.33 mmol) was add under N₂ atmosphere. After that, freeze-degassing was carried out for further three times to create an oxygen-free environment for an atom transfer radical polymerization system. Then the Schlenk reaction tube under N₂ atmosphere was placed into an oil bath of 50° C. for 6 hours with stirring. The reaction was quenched by passing air into the system under ice-water condition. The resultant product was rotary evaporated to remove solvent methanol, then was purified by a neutral alumina column using tetrahydrofuran as eluent. The purified product was precipitated drop by drop in iced n-hexane. The precipitated product was allowed to stand for 30 minutes in low-temperature environment, then the supernatant was removed. The resultant product was dried in a vacuum oven for 6 hours at 50° C., to obtain a yellowish, viscous solid final polymer product (thymol-PDMAEMA₁₀, yield: 50%).

### Comparative Example 1 Preparation of PDMAEMA

PDMAEMA was prepared by the polymerization procedure of example 1, except that methyl 2-bromoisobutyrate was used as the initiator instead of the menthol-based initiator. The resultant final polymer product is named as PDMAEMA₁₀.

### Comparative Example 2 Preparation of Polymer Menthol-PHEMA

The menthol-based initiator obtained from example 1 (1 mmol, 0.305 g), 2-Hydroxyethyl methacrylate (10 mmol, 1.3 g), N,N,N′,N″,N″-pentamethyldiethylenetriamine (2 mmol, 0.412 ml), and methanol (15 mL) were charged successively into a gas-tight Schlenk reaction tube under N₂ atmosphere. The resultant reaction system was freeze-degassed, then purified CuBr powder (2 mmol, 0.288 g) was add under N₂ atmosphere. After that, freeze-degassing was carried out for further three times to create an oxygen-free environment for an atom transfer radical polymerization system. Then the Schlenk reaction tube under N₂ atmosphere was placed into an oil bath of 55° C. for 24 hours with stirring. The reaction was quenched by passing air into the system under ice-water condition. The resultant product was rotary evaporated to remove solvent methanol, then was purified by a Neutral alumina column using a mixture of butanone and n-propanol (butanone:n-propanol=7:3 V/V) as eluent. The purified product was precipitated drop by drop in ethyl ether. The precipitated product was allowed to stand for 30 minutes in low-temperature environment, then the supernatant was removed. The resultant product was dried in a vacuum oven for 6 hours at 50° C., to obtain a dark yellow, viscous solid final polymer product (Menthol-PHEMA₁₀, yield: 52%).

### Example 4 Property Characterization

Properties of each polymer were tested according to the methods introduced above. The results were provided in tables 1 to 5.

In these tables, polymer products of the atom transfer radical polymerization were represented by formulae of Menthol-PDMAEMAₓ or Thymol-PDMAEMAₓ, the subscript means the polymerization degree of the polymer. For example, “Menthol-PDMAEMA₁₁” means the polymerization degree of this polymer is 11. The polymers with formulae of Menthol-PDMAEMAₓ were prepared according to the procedures disclosed in example 1, wherein the feed ratio was adjusted for obtaining different polymerization degrees. The polymers with formulae of Thymol-PDMAEMAₓ were prepared according to the procedures disclosed in example 3, wherein the feed ratio was adjusted for obtaining different polymerization degrees.

In these tables, polymer products of the radical polymerization were represented by formulae of PMₓ-r-D_{y}, the subscripts mean the average number of each structural unit, “r” means it is a random polymer. For example, “PM₁-r-D₁₇” means the average number of the structural unit derived from menthyl methacrylate is 1 and the average number of the structural unit derived from DMAEMA is 17. The polymers with formulae of PMₓ-r-D_{y} were prepared according to the procedures disclosed in example 2, wherein the feed ratio was adjusted for obtaining different average numbers of the structural units.

The polymers with formulae of PDMAEMAₓ (the subscript means the polymerization degree of the polymer) were prepared according to the procedures disclosed in comparative example 1, wherein the feed ratio was adjusted for obtaining different polymerization degrees.

TABLE 1

| | polymerization | | Molecular |
|---|---|---|---|
| Name | degree (DP) | PDI | weight (g/mol) |
| Menthol-PDMAEMA₁₁ | 11 | 1.28 | 2020 |
| Menthol-PDMAEMA₁₉ | 19 | 1.39 | 3290 |
| Menthol-PDMAEMA₂₈ | 28 | 1.49 | 4700 |
| Menthol-PDMAEMA₃₉ | 39 | 1.41 | 6430 |
| Menthol-PDMAEMA₉₇ | 97 | 1.93 | 15530 |
| PDMAEMA₁₀ | 10 | 1.66 | 1750 |

TABLE 2

| | MIC (μg/mL) | | MBC (μg/mL) | |
|---|---|---|---|---|
| Name | E. coli | S. aureus | E. coli | S. aureus |
| Menthol-PDMAEMA₁₁ | 62.5 | 125 | 250 | 250 |
| Menthol-PDMAEMA₁₉ | 125 | 250 | 500 | 500 |
| Menthol-PDMAEMA₂₈ | 125 | 500 | 500 | 500 |
| Menthol-PDMAEMA₃₉ | 250 | 500 | 1000 | 1000 |
| Menthol-PDMAEMA₉₇ | 250 | 500 | 1000 | 1000 |
| PDMAEMA₁₀ | 500 | 1000 | 2000 | 4000 |
| Menthol-PHEMA₁₀ | >2000 | >2000 | / | / |

TABLE 3

| | polymerization | Molecular weight | MIC(μg/mL) | |
|---|---|---|---|---|
| Name | degree (DP) | (g/M) | E. coli | S. aureus |
| PM₁-r-D₁₇ | 18 | 2900 | 125 | 500 |
| PM₂-r-D₁₈ | 20 | 3200 | 125 | 500 |
| PM₃-r-D₁₅ | 18 | 3000 | 125 | 500 |
| PM₄-r-D₁₂ | 16 | 2900 | 500 | 500 |

TABLE 4

| | Polymerization | | Molecular |
|---|---|---|---|
| Name | degree (DP) | PDI | weight (g/mol) |
| Thymol-PDMAEMA₈ | 8 | 1.46 | 1556 |
| Thymol-PDMAEMA₁₄ | 14 | 1.21 | 2498 |
| Thymol-PDMAEMA₁₉ | 19 | 1.41 | 3283 |
| Thymol-PDMAEMA₃₅ | 35 | 1.27 | 5795 |
| Thymol-PDMAEMA₅₃ | 53 | 1.40 | 8621 |
| PDMAEMA₈ | 8 | 1.54 | 1437 |
| PDMAEMA₁₅ | 15 | 1.40 | 2536 |
| PDMAEMA₂₂ | 22 | 1.70 | 3635 |
| PDMAEMA₃₁ | 31 | 1.99 | 5048 |
| PDMAEMA₅₂ | 52 | 1.70 | 8345 |

TABLE 5

| | MIC (μg/mL) | | | MBC (μg/mL) | | |
|---|---|---|---|---|---|---|
| Name | E. coli | S. aureus | MRSA | E. coli | S. aureus | MRSA |
| Thymol | 250 | 250 | 250 | 250 | 250 | 250 |
| Thymol-PDMAEMA₈ | 31.25 | 31.25 | 31.25 | 62.5 | 125 | 62.5 |
| Thymol-PDMAEMA₁₄ | 62.5 | 125 | 125 | 125 | 250 | 125 |
| Thymol-PDMAEMA₁₉ | 125 | 125 | 250 | 250 | 250 | 250 |
| Thymol-PDMAEMA₃₅ | 250 | 500 | 250 | 250 | 500 | 250 |
| Thymol-PDMAEMA₅₃ | 250 | 500 | 500 | 250 | 1000 | 500 |
| PDMAEMA₈ | 2000 | 8000 | 4000 | 2000 | 8000 | 8000 |
| PDMAEMA₁₅ | 1000 | 4000 | 4000 | 2000 | 8000 | 8000 |
| PDMAEMA₂₂ | 500 | 2000 | 2000 | 1000 | 8000 | 4000 |
| PDMAEMA₃₁ | 500 | 1000 | 1000 | 500 | 1000 | 2000 |

It can be seen that that polymer of the present invention obtained further improved antibacterial effects over antibacterial polymers prepared merely from antibacterial tertiary amine monomers and without moiety B′ of the invention or prepared from 2-Hydroxyethyl methacrylate. Furthermore, the processes of the present invention are able to obtain polymers with controllable molecular weights, and narrow polydispersity index.

1.-25. (canceled)

26. A polymer, containing a structural unit A′ derived from a monomer A and a moiety B′ derived from a compound B, wherein:
monomer A contains a nitrogen atom and a polymerizable carbon-carbon double bond, and
compound B is selected from a group consisting of bicyclic monoterpenes, monocyclic monoterpenes, acyclic monoterpenes, and C₁₋₁₀ alkyl-substituted phenol,
wherein the bicyclic monoterpene is selected from pinene-based compounds containing hydroxy, carene-based compounds containing hydroxy, chrysanthanol, and fenchol.

27. The polymer of claim 26, wherein the nitrogen atom in monomer A is substituted with one or two C₁₋₁₀ alkyl groups.

28. The polymer of claim 26, wherein monomer A is selected from (di-C₁₋₅alkyl-amino)C₁₋₅alkyl (meth)acrylate and (C₁₋₅alkyl-amino)C₁₋₅alkyl (meth)acrylate.

29. The polymer of claim 26, wherein monomer A is hydrophilic.

30. The polymer of claim 26, wherein compound B carries a OH group.

31. The polymer of claim 26, wherein compound B is modified to a compound B-based initiator, or to a monomer C containing a polymerizable carbon-carbon double bond and the moiety B′, and the moiety B′ is incorporated into the polymer via the compound B-based initiator and/or monomer C.

32. The polymer of claim 26, wherein the polymer is formed by atom transfer radical polymerization of monomer A, and moiety B′ is positioned at the end of the polymer, wherein the average number of structural unit A′ in the polymer is in the range from 5 to 150.

33. The polymer of claim 31, wherein the polymer is formed by radical polymerization of monomer A and monomer C,
wherein the average number of structural unit A′ is in the range from 10 to 50; and
the average number of the structural unit derived from monomer C is in the range from 1 to 10.

34. The polymer of claim 33, wherein the polymer is a random copolymer.

35. A process of preparing the polymer of claim 26, comprising:
(1) modifying compound B to prepare a compound B-based initiator; and
(2) polymerizing monomer A via atom transfer radical polymerization using the compound B-based initiator obtained in step (1), to obtain the polymer.

36. The process of claim 35, wherein step (1) is carried out by modifying compound B with an agent having formula RCOX, wherein X is a halogen; R is a C₁₋₆ alkyl substituted with one halogen atom.

37. The process of claim 35, wherein step (2) of the process is carried out in the presence of a catalyst system containing a catalyst and a ligand.

38. The process of claim 37, wherein the molar ratio of the compound B-based initiator to the catalyst for step (2) is in the range from 1:1 to 1:3.

39. The process of claim 35, wherein step (2) is carried out in the presence of a solvent.

40. The process of claim 35, wherein step (2) is carried out at a temperature of 35° C. to 65° C.

41. The process of claim 35, wherein step (2) is carried out for a time of 4 to 40 hours.

42. The process of claim 35, wherein the polymerization degree of the polymer from step (2) is in the range from 10 to 150.

43. A process of preparing a polymer of claim 33, comprising:
(i) modifying a compound B to prepare a monomer C containing a polymerizable carbon-carbon double bond and a moiety B′ derived from compound B; and
(ii) polymerizing the monomer C and monomer A via radical polymerization, in the presence of an initiator and a chain-transfer agent, to obtain the polymer;
wherein monomer A contains a nitrogen atom and a polymerizable carbon-carbon double bond, and
compound B is selected from a group consisting of bicyclic monoterpenes, monocyclic monoterpenes, acyclic monoterpenes, and C₁₋₁₀ alkyl-substituted phenol,
wherein the bicyclic monoterpene is selected from pinene-based compounds containing hydroxy, carene-based compounds containing hydroxy, chrysanthanol, and fenchol.

44. The process of claim 43, wherein step (i) is carried out by modifying compound B with an unsaturated carbonyl halide.

45. The process of claim 43, wherein step (ii) is carried out in the presence of a solvent.

46. The process of claim 43, wherein the initiator used in step (ii) is an azo type of initiator.

47. The process of claim 43, wherein the chain-transfer agent used in step (ii) is a mercaptan.

48. The process of claim 43, wherein step (ii) is carried out at a temperature of 35° C. to 73° C.

49. The process of claim 43, wherein step (ii) is carried out for a time of 5 to 40 hours.

50. The process of claim 43, wherein the average number of the structural unit A′ derived from monomer A in the polymer from step (ii) is in the range from 10 to 50; and
the average number of the structural unit derived from monomer C in the polymer from step (ii) is in the range from 1 to 10.
